(19) United States
(12) Patent Application Publication
(10) Pub. No.: US 2024/0067771 A1
(43) Pub. Date: Feb. 29, 2024

(54) NEW CATALYST FOR PRODUCING POLYURETHANES

(71) Applicant: BASF SE, Ludwigshafen (DE)

(72) Inventors: Mikko Juhani Artturi MUURONEN, Schilde (BE); Markus SCHUETTE, Lemfoerde (DE); Heinz-Dieter LUTTER, Lemfoerde (DE); Manuela FAEHMEL, Lemfoerde (DE); Maximilian JOOST, Lemfoerde (DE); Alexander Michael HAYDL, Ludwigshafen (DE); Peter DEGLMANN, Ludwigshafen (DE); Patrick BOLDUAN, Lemfoerde (DE); Max Julian SIEBERT, Ludwigshafen (DE)

(21) Appl. No.: 18/258,054

(22) PCT Filed: Dec. 16, 2021
(86) PCT No.: PCT/EP2021/086325

§ 371 Date: Jun. 16, 2023

(30) Foreign Application Priority Data
Dec. 23, 2020 (EP) 20216908.2

(51) Int. Cl. C08G 18/48; C08G 18/20; C08G 18/40; C08G 18/76; C08J 9/12

(52) U.S. Cl. CPC C08G 18/4841; C08G 18/2027; C08G 18/4072; C08G 18/7671; C08J 9/125; C08G 2110/0008; C08G 2110/0033; C08G 2110/005; C08G 2110/0058; C08G 2110/0083; C08J 2203/10; C08J 2375/08

(57) ABSTRACT

Disclosed herein is a process for producing polyurethanes including mixing (a) aromatic polyisocyanate with (b) polymeric compounds having isocyanate-reactive groups, (c) optionally chain extender and/or crosslinking agent, (d) catalyst, (e) 0.1% to 5% by weight, based on the total weight of the components (a) to (f), of at least one cyclic urea structure of general formula 1

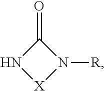

where —X— represents a substituted or unsubstituted, 3-membered radical and R represents a radical (f) optionally blowing agent and (g) optionally additives to afford a reaction mixture and reacting the reaction mixture to afford the polyurethane. Further disclosed herein are a polyurethane obtainable by such a process and a method of using such a polyurethane foam for producing cushions, seat pads and mattresses.

The present invention relates to a process for producing polyurethanes comprising mixing (a) aromatic polyisocyanate with (b) polymeric compounds having isocyanate-reactive groups, (c) optionally chain extender and/or crosslinking agent, (d) catalyst, (e) 0.1% to 5% by weight, based on the total weight of the components (a) to (f), of at least one cyclic urea structure of general formula 1

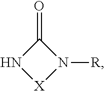

wherein —X— represents a substituted or unsubstituted, 3-membered radical and R represents a radical selected from a substituted or unsubstituted alkyl or heteroalkyl group, a substituted or unsubstituted aryl group or a substituted or unsubstituted alkyl-aryl or heteroalkyl-aryl group, (f) optionally blowing agent and (g) optionally additives to afford a reaction mixture and reacting the reaction mixture to afford the polyurethane. The present invention further relates to a polyurethane, preferably a polyurethane foam, obtainable by such a process and to the use of such a polyurethane foam for producing cushions, seat pads and mattresses.

Polyurethanes and polyurethane catalysts are known. In the production of the polyurethanes the reaction of the isocyanates and polyolsis typically carried out in the presence of catalyst, in particular strongly basic amine catalysts comprising tertiary nitrogen atoms or metal catalysts. Disadvantages of metal catalysts include that they comprise heavy metals and are therefore not very environmentally friendly. Metal catalysts also have a tendency to undergo hydrolysis and lose their catalytic activity in the presence of water. This has the result that their use in reaction pre-mixtures, such as a so-called polyol component, is possible only to a limited extent, thus excluding many metal compounds.

Strongly basic amine catalysts are much more stable but have the disadvantage that they tend to migrate out of the finished polyurethane and thus result in undesired emissions of volatile organic compounds and also odor emissions. Known strongly basic catalysts often also cause further emissions of organic compounds, for example of aldehydes. This is undesired especially when using polyurethanes in enclosed spaces, for example as seat pads, mattresses or in automotive interiors.

Such applications therefore often employ incorporable catalysts which comprise an isocyanate-reactive group and are co-incorporated into the polyurethane structure during polyurethane. While this does make it possible to reduce the undesired emissions of the catalysts, incorporable catalysts have the disadvantage that they also catalyze the reverse reaction and thus chain degradation. Polyurethanes with incorporable catalysts therefore often have impaired aging properties. The emissions of aldehydes cannot be avoided by incorporable catalysts either.

There is therefore a need for catalysts which do not have these disadvantages. One example is lactams. These have the disadvantage that they have only low activity and must be employed in very large amounts. However, this has adverse effects on the mechanical properties in the polyurethane. Lactams are therefore typically employed together with strongly basic amine catalysts.

A further disadvantage of traditional strongly basic amine catalysts is that large amounts of these catalysts in the production of flexible polyurethane foams in particular at water contents of greater than 1% by weight and an isocyanate index of less than 100 result in aromatic amines, in particular toluene diamine (TDA) and methylene diphenylene diamine (MDA), being detectable in a concentration range of 10-200 ppm. These occur in particular on the surface of molded foams. Because of their carcinogenic and genotoxic potential, aromatic amines have been subject to numerous internal and external studies for centuries. Known measures for reducing the content of aromatic amines involve the use of reactive scavenger compounds such as for example carboxylic anhydrides or aliphatic isocyanates.

WO 2020/161010 describes the use of lactams to reduce aromatic amines in such foams. Such harmful aromatic amines occur in particular with isocyanate indices of less than 100. One possible explanation for this is the fact insufficient isocyanate groups are available to further react with MDA formed by the isocyanate-water reaction to afford urea bonds during formation of the polyurethane foams. The MDA thus formed can in particular accumulate at the interface with the relatively cold mold surface by condensation during production of molded foams.

However, one disadvantage of the solution described in WO 2020/161010 is that it entails the use of relatively large amounts of lactams and the presence of metal catalysts and strongly basic amine catalysts is also indispensable.

WO 2015050876 describes the use of 5-membered polyureas to reduce the aldehyde content in amine catalysts contaminated with aldehyde. WO 2016005479 describes the use of cyclic ureas having isocyanate-reactive groups as aldehyde scavengers in the production of polyurethanes.

It is accordingly an object of the present invention to provide a catalyst for the polyurethane reaction which does not exhibit the abovementioned disadvantages of the strongly basic amine catalysts and the metal catalysts and is more active than the known lactams, so that significant proportions of these catalysts may be replaced without adverse effects on the mechanical properties of the obtained polyurethanes. This is especially intended to reduce the emission of organic, volatile compounds. It is a further object of the present invention to provide a polyurethane catalyst which makes it possible to produce polyurethane foams which, despite a high content of environmentally friendly blowing agent water and a low isocyanate index of less than 95, affords foams having a markedly reduced content of aromatic amines, especially at the surface of molded foams.

The object of the invention is achieved by a process for producing polyurethanes comprising mixing (a) aromatic polyisocyanate with (b) polymeric compounds having isocyanate-reactive groups, (c) optionally chain extenders and/or crosslinkers, (d) catalyst, (e) 0.1% to 5% by weight, based on the total weight of the components (a) to (f), of at least one cyclic urea structure of general formula 1

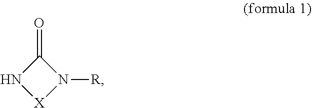

wherein —X— represents a substituted or unsubstituted, 3-membered radical and R represents a radical selected from a substituted or unsubstituted alkyl or heteroalkyl group, a substituted or unsubstituted aryl group or a substituted or unsubstituted alkyl-aryl or heteroalkyl-aryl group, (f) optionally blowing agent and (g) optionally additives to afford a reaction mixture and reacting the reaction mixture to afford the polyurethane. The present object is also achieved by a polyurethane, preferably a polyurethane foam, obtainable by such a method.

The term polyurethane in the context of the invention comprises all known foamed polyisocyanate polyaddition products. These comprise addition products of isocyanate and alcohol, and also modified polyurethanes, which can comprise isocyanurate, allophanate, urea, carbodiimide, uretonimine or biuret structures, and other isocyanate addition products. These polyurethanes according to the invention comprise in particular solid polyisocyanate polyaddition products, such as duromers, and foams based on polyisocyanate-polyaddition products, such as flexible foams, semi-rigid foams, rigid foams or molded foams and also polyurethane coatings and binders. “Polyurethanes” are further to be understood as meaning polymer blends comprising polyurethanes and further polymers, and also foams made of these polymer blends. The polyurethanes according to the invention are preferably polyurethane foams or solid polyurethanes which comprise no further polymers in addition to the polyurethane units (a) to (g) elucidated hereinbelow.

In the context of the invention “polyurethane foams” are understood as meaning foams in accordance with DIN 7726. Flexible polyurethane foams according to the invention have a compressive stress at 10% compression/compressive strength according to DIN 53 421/DIN EN ISO 604 of 15 kPa or less, preferably 1 to 14 kPa and in particular 4 to 14 kPa. Semi-rigid polyurethane foams according to the invention have a compressive stress at 10% compression according to DIN 53 421/DIN EN ISO 604 of more than 15 to less than 80 kPa. According to DIN ISO 4590 semi-rigid polyurethane foams and flexible polyurethane foams according to the invention have an open-cell content of preferably more than 85%, particularly preferably more than 90%. Further details about flexible polyurethane foams and semi-rigid polyurethane foams according to the invention may be found in “Kunststoffhandbuch”, volume 7, “Polyurethane”, Carl Hanser Verlag, 3rd edition 1993, chapter 5.

The rigid polyurethane foams according to the invention exhibit a compressive stress at 10% compression of not less than 80 kPa, preferably not less than 120 kPa, particularly preferably not less than 150 kPa. Furthermore, the rigid polyurethane foam has a closed-cell content of more than 80%, preferably more than 90%, according to DIN ISO 4590. Further details about rigid polyurethane foams according to the invention may be found in “Kunststoffhandbuch”, volume 7, “Polyurethane”, Carl Hanser Verlag, 3rd edition 1993, chapter 6.

In the context of the present invention “elastomeric polyurethane foams” is to be understood as meaning polyurethane foams according to DIN 7726 which after brief deformation by 50% of their thickness according to DIN 53 577 show no lasting deformation above 2% of their starting thickness after 10 minutes. This may be a flexible polyurethane foam for example.

Polyurethane molded foams are polyurethane foams according to DIN 7726 which, as a consequence of the shaping process, have an outer skin or an edge zone that has a higher density than the core. The overall apparent density averaged over the core and the edge zone is preferably in the range from 15 to 800 g/L. Molded foams having a density greater than 100 g/L are typically referred to as integral skin foams. In the context of the present invention polyurethane molded foams may also be rigid polyurethane foams, semi-rigid polyurethane foams or flexible polyurethane foams. Further details about polyurethane integral skin foams according to the invention may be found in “Kunststoffhandbuch”, volume 7, “Polyurethane”, Carl Hanser Verlag, 3rd edition 1993, chapter 7. The polyurethanes according to the invention are preferably polyurethane foams, particularly preferably rigid polyurethane foams, semi-rigid polyurethane foams or flexible polyurethane foams, in particular flexible polyurethane foams, very particularly preferably molded flexible polyurethane foams.

The polyurethane according to the invention is preferably employed in the interior of means of transport, such as ships, airplanes, lorries, passenger cars or buses, especially passenger cars or buses and especially cars. The interior of passenger cars and buses is hereinbelow referred to as an automotive interior part. A flexible polyurethane foam can be used as a seat cushion, a semi-rigid polyurethane foam as back-foaming for door trim elements or instrument panels, an integral polyurethane foam as a steering wheel, shift knob or headrest and a solid polyurethane as a cable sheathing for example.

The polyisocyanate components (a) used for producing the polyurethanes according to the invention comprise all polyisocyanates known for the production of polyurethanes. These comprise the aliphatic, cycloaliphatic and aromatic divalent or polyvalent isocyanates known from the prior art and any desired mixtures thereof. Examples are diphenylmethane 2,2′-, 2,4′- and 4,4′-diisocyanate, the mixtures of monomeric diphenylmethane diisocyanates with diphenylmethane diisocyanate homologs having a larger number of rings (polymer MDI), isophorone diisocyanate (IPDI) and its oligomers, tolylene 2,4- or 2,6-diisocyanate (TDI) and mixtures of these, tetramethylene diisocyanate and its oligomers, hexamethylene diisocyanate (HDI) and its oligomers, naphthylene diisocyanate (NDI) and mixtures thereof.

These preferably comprise toluene diisocyanate isomers (TDI isomers) and isomers of methylenediphenylene diisocyanate and its higher polycyclic homologs (referred to as MDI). The aromatic polyisocyanate used is particularly preferably a mixture comprising 2,4′-MDI, 4,4′-MDI and higher polycyclic homologs of MDI. It is furthermore also possible to use modified isocyanates, such as isocyanates which are formed by incorporation of groups derived from isocyanate groups in the polyisocyanates. Examples of such groups are allophanate, carbodiimide, uretonimine, isocyanurate, urea and biuret groups. In a preferred embodiment, the proportion of diphenylmethane 2,4′-diisocyanate is preferably 5% to 30% by weight and that of diphenylmethane 4,4′-diisocyanate is preferably 40% to 80% by weight, based in each case on the total weight of aromatic polyisocyanates (a). In a preferred embodiment, the proportion of higher polycyclic homologs of diphenylmethane diisocyanate is 3% to 30% by weight, particularly preferably 5% to 25% by weight.

The aromatic polyisocyanates may also be used in the form of prepolymers. To this end, the aromatic polyisocyanates (a1) described above are reacted in excess with compounds comprising isocyanate-reactive compounds (a2). The compounds (a2) used here are preferably the polymeric compounds having isocyanate-reactive groups which are mentioned under (b). If isocyanate prepolymers are used as aromatic isocyanates (a), these preferably have an NCO content of 16% to 31% by weight.

Polymeric compounds having isocyanate-reactive groups (b) have a number-average molecular weight of at least 450 g/mol, particularly preferably 460 to 12 000 g/mol and have at least two isocyanate-reactive hydrogen atoms per molecule. Preferred polymeric compounds having isocyanate-reactive groups (b) which can be considered are polyester alcohols, and/or polyether alcohols having a functionality of 2 to 8, in particular of 2 to 6, preferably of 2 to 4, and a mean equivalent molecular weight in the range from 400 to 3000 g/mol, preferably 1000 to 2500 g/mol. Polyether alcohols are used in particular.

The polyether alcohols can be produced by known methods, usually by catalytic addition of alkylene oxides, especially ethylene oxide and/or propylene oxide, onto H-functional starter substances, or by condensation of tetrahydrofuran. When alkylene oxides are added on, the term polyalkylene oxide polyols is also used. H-functional starter substances that can be used are in particular polyfunctional alcohols and/or amines. Preference is given to using water, dihydric alcohols, for example ethylene glycol, propylene glycol, or butanediols, trihydric alcohols, for example glycerol or trimethylolpropane, and higher polyhydric alcohols, such as pentaerythritol, sugar alcohols, for example sucrose, glucose or sorbitol. Amines used with preference are aliphatic amines having up to 10 carbon atoms, for example ethylenediamine, diethylenetriamine, propylenediamine, and amino alcohols such as ethanolamine or diethanolamine. Alkylene oxides used are preferably ethylene oxide and/or propylene oxide, where in the case of polyether alcohols, which are used for the production of flexible polyurethane foams, an ethylene oxide block is frequently added on to the chain end. Catalysts used when adding on the alkylene oxides are in particular basic compounds, with potassium hydroxide having the greatest industrial significance here. If the intention is to have a low content of unsaturated constituents in the polyether alcohols, catalysts used may also be di- or multi-metal cyanide compounds, so-called DMC catalysts. Di- and/or trifunctional polyalkylene oxide polyols are used in particular for the production of viscoelastic flexible polyurethane foams.

In addition, the compound having at least two active hydrogen atoms used can be polyester polyols, producible for example from organic dicarboxylic acids having 2 to 12 carbon atoms, preferably aliphatic dicarboxylic acids having 8 to 12 carbon atoms and polyhydric alcohols, preferably diols, having 2 to 12 carbon atoms, preferably 2 to 6 carbon atoms. Examples of useful dicarboxylic acids include: succinic acid, glutaric acid, adipic acid, suberic acid, azelaic acid, sebacic acid, decanedicarboxylic acid, maleic acid, fumaric acid, phthalic acid, isophthalic acid, terephthalic acid, and the isomeric naphthalenedicarboxylic acids. Preference is given to using adipic acid. The dicarboxylic acids may be used here either individually or in a mixture with one another. Instead of the free dicarboxylic acids it is also possible to use the corresponding dicarboxylic acid derivatives, for example dicarboxylic esters of alcohols having 1 to 4 carbon atoms or dicarboxylic anhydrides.

Examples of di- and polyhydric alcohols, especially diols, are: ethanediol, diethylene glycol, propane-1,2- and -1,3-diol, dipropylene glycol, butane-1,4-diol, pentane-1,5-diol, hexane-1,6-diol, decane-1,10-diol, glycerol and trimethylolpropane. It is preferable to use ethanediol, diethylene glycol, butane-1,4-diol, pentane-1,5-diol, hexane-1,6-diol or mixtures of at least two of the diols mentioned, in particular mixtures of butane-1,4-diol, pentane-1,5-diol and hexane-1,6-diol. It is also possible to use polyester polyols formed from lactones, for example ε-caprolactone, or hydroxycarboxylic acids, for example ω-hydroxycaproic acid and hydroxybenzoic acids. Preference is given to using dipropylene glycol.

Chain extenders and/or crosslinking agents (c) used are substances having a molecular weight of less than 400 g/mol, preferably of 60 to 350 g/mol, with chain extenders having 2 isocyanate-reactive hydrogen atoms and crosslinking agents having at least 3 isocyanate-reactive hydrogen atoms. These may be used individually or in the form of mixtures. It is preferable to employ diols and/or triols having molecular weights of less than 400, particularly preferably of 60 to 300 and in particular 60 to 150. Useful examples of starter molecules include aliphatic, cycloaliphatic and/or aromatic diols, and diols including aromatic structures, having 2 to 14, preferably 2 to 10, carbon atoms, for example ethylene glycol, propane-1,3-diol, decane-1,10-diol, o-, m-, p-dihydroxycyclohexane, diethylene glycol, dipropylene glycol and preferably butane-1,4-diol, hexane-1,6-diol and bis(2-hydroxyethyl)hydroquinone, triols such as 1,2,4-, 1,3,5-trihydroxycyclohexane, glycerol and trimethylolpropane and low molecular weight hydroxyl group-containing polyalkylene oxides based on ethylene oxide and/or 1,2-propylene oxide and the aforementioned diols and/or triols. Chain extenders (c) used are particularly preferably monoethylene glycol, butane-1,4-diol and/or glycerol.

If chain extenders, crosslinking agents or mixtures thereof are used, these are advantageously used in amounts of 0.1% to 20% by weight, preferably 0.5% to 10% by weight and in particular 0.8% to 5% by weight, based on the weight of components (b) and (c).

Suitable catalysts (d) for producing the polyurethane foams according to the invention include all known polyurethane catalysts. These include metal catalysts and/or amine catalysts having tertiary nitrogen atoms. According to the invention compounds (e) having at least one cyclic urea structure of general formula 1 are not deemed to be a catalyst (d). The catalyst (d) preferably comprises amine catalyst, wherein the amine catalyst comprises tertiary nitrogen atoms.

When amine catalysts are employed it is preferable in the context of the present invention to employ compounds with a tertiary nitrogen atom having a relative reactivity, based on triethylenediamine, of at least 5%. The relative reactivity is ascertained here by ascertaining the rate constant of the compound to be tested in the butanol-phenyl isocyanate model system with a concentration of 0.50 mol/liter in each case at 50° C. in the solvent acetonitrile and comparing it with that of 1,4-diazabicyclo[2.2.2]octane (triethylenediamine). A relative reactivity of at least 5% results if the rate constant for the catalyst to be tested under otherwise identical conditions is smaller than the rate constant when using 1,4-diazabicyclo[2.2.2]octane by at most a factor of 20. Details about determining the rate constant are described in Schwetlick et. Al. Im J. Chem. Soc Perkin Trans. 2, 1994, pages 599 to 608 (rate constant k_{b} for 1,4-diazabicyclo[2.2.2]octane under the recited conditions=2.68 dm⁶ mol⁻² s⁻¹).

The amine catalysts preferably comprise reactive amine catalysts, that is to say those comprising isocyanate-reactive groups. These have at least one, preferably 1 to 8 and particularly preferably 1 to 2, isocyanate-reactive groups such as primary amine groups, secondary amine groups, hydroxyl groups, amides or urea groups, preferably primary amine groups, secondary amine groups or hydroxyl groups and particularly preferably primary amine groups or hydroxyl groups. Incorporable amine catalysts are mostly used for the production of low-emission polyurethanes which are especially used in automotive interiors. Such catalysts are known and described for example in EP1888664. They comprise compounds which, in addition to the isocyanate-reactive group(s), have one or more, preferably two, tertiary amino groups.

It is preferable when the tertiary amino groups of the incorporable catalysts bear at least two aliphatic hydrocarbon radicals, preferably having 1 to 10 carbon atoms per radical, particularly preferably having 1 to 6 carbon atoms per radical. It is particularly preferable when the tertiary amino groups bear two radicals independently of one another selected from methyl (H₃C—) and ethyl radicals(H₃C—H₂C—) and a further organic radical. Examples of incorporable catalysts that are used in a preferred embodiment of the invention are selected from the group consisting of bisdimethylaminopropylurea, bis(N,N-dimethylaminoethoxyethyl)carbamate, dimethylaminopropylurea, N,N,N-trimethyl-N-hydroxyethylbis(aminopropyl ether), N,N,N-trimethyl-N-hydroxyethylbis(aminoethyl ether), diethylethanolamine, bis(N,N-dimethyl-3-aminopropyl)amine, dimethylaminopropylamine, 3-dimethylaminopropyl-N,N-dimethylpropane-1,3-diamine, dimethyl-2-(2-aminoethoxyethanol) and (1,3-bis(dimethylamino)propan-2-ol), N,N-bis(3-dimethylaminopropyl)-N-isopropanolamine, bis(dimethylaminopropyl)-2-hydroxyethylamine, N,N,N-trimethyl-N-(3 aminopropyl)bis(aminoethyl ether), 3-dimethylaminoisopropyldiisopropanolamine, N-[2-[2-(dimethylamino)ethoxy]ethyl]-N-methyl-1,3-propanediamine and mixtures thereof. Particular preference is given to using N-[2-[2-(dimethylamino)ethoxy]ethyl]-N-methyl-1,3-propanediamine.

In addition to the incorporable amine catalysts, it is possible to use further amine catalysts for producing the polyurethanes. These are preferably selected from the group consisting of 2,3-dimethyl-3,4,5,6-tetrahydropyrimidine, triethylamine, tributylamine, dimethylbenzylamine, N-methyl-, N-ethyl-, N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyl diaminoethyl ether, bis(dimethylaminopropyl)urea, dimethylpiperazine, 1,2-dimethylimidazole, 1-azabicyclo[3.3.0]octane and preferably 1,4-diazabicyclo[2.2.2]octane, and mixtures thereof.

The amine catalyst is preferably employed in an amount such that the content of tertiary nitrogen atoms is from 0.0001 to 0.003 mol/100 g of foam, preferably 0.0004 to 0.002 and in particular 0.0005 to 0.001 mol per 100 g of foam. The amine catalysts preferably comprise exclusively incorporable amine catalysts.

Metal catalysts used can be any customary metal catalysts. These include organic metal compounds, preferably organic tin compounds, such as tin(II) salts of organic carboxylic acids, for example tin(II) acetate, tin(II) octoate, tin(II) ethylhexanoate and tin(II) laurate, and the dialkyltin(IV) salts of organic carboxylic acids, for example dibutyltin diacetate, dibutyltin dilaurate, dibutyltin maleate and dioctyltin diacetate, dibutyltin dineodecanoate, and also bismuth carboxylates, such as bismuth(III) neodecanoate, bismuth 2-ethylhexanoate and bismuth octanoate, or mixtures thereof. Metal catalysts selected are preferably those metal catalysts which are stable to hydrolysis, such as for example tin(IV) compounds. Dibutyltin dineodecanoate is used as metal catalyst in particular.

The catalysts and the catalyst amounts to be used are preferably selected here such that the polyurethane reaction mixture preferably has a rise time of 30 to 150 seconds, particularly preferably 40 to 110 seconds and in particular 50 to 105 seconds, taking into account the limitation of amount according to the invention for tertiary nitrogen. The rise time is understood to be the time to reach the maximum height in the beaker test with a weight of 100 g of polyol component and 50 g of isocyanate component. The cream time is preferably in the range from 10 to 30 seconds, particularly preferably 12 to 25 seconds and in particular 14 to 22 seconds, and the gel or fiber time is preferably 60 to 180 seconds, particularly preferably 70 to 160 seconds, and in particular 75 to 145 seconds. The cream time and gel time are determined here according to DIN EN 14315-1:2013 at 25° C. in the beaker test with a weight of 100 g of polyol component and 50 g of isocyanate component.

Employed as component (e) according to the invention is a cyclic urea structure of formula 1

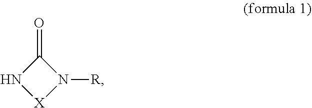

in an amount of 0.1% to 5% by weight, preferably 0.2% to 3% by weight and in particular 0.3% to 2% by weight, based on the total weight of the components (a) to (f), wherein —X— represents a 3-membered radical which may be substituted. This forms a cyclic urea structure of formula 1, whose ring has 6 members including the urea structure —NH—C(O)—NR—. The members of the radical X are preferably selected from the group consisting of —NR¹—, —O—, —CR²R³—, —N═ and —CR⁴═. In the case of the radical —CR⁴═ oder —N═ the neighboring member naturally likewise consists of a member selected from —CR₄═ oder —N═ to allow formation of the double bond between the two members. The radicals R¹ to R⁴ each independently of one another represent hydrogen, an alkyl radical, preferably ethyl or methyl, or halogen, for example a fluoride radical or a chloride radical. In a very particularly preferred embodiment X is —(CH₂)₃— or —CH₂—C(CH₃)₂—CH₂—, in particular —(CH₂)₃—. The radical R of formula 1 represents a substituted or unsubstituted alkyl or heteroalkyl group, a substituted or unsubstituted aryl group or a substituted or unsubstituted alkyl-aryl or heteroalkyl-aryl group. Suitable substituents nclude for example halide groups, alkyl groups, hydroxyl groups or amine groups. In a preferred embodiment of the invention R comprises at least one isocyanate-reactive hydrogen atom, for example an —OH or —NH₂ group. R preferably represents methyl, ethyl, propyl, pentyl, hexyl, one or more alkylene oxide units, for example oxyethylene, oxypropylene or mixtures of oxyethylene and oxypropylene, and phenyl, or phenyl ether. R particularly preferably represents methyl, ethyl, oxyethylene, oxypropylene or phenylmethoxy ester, very particularly preferably methyl. Also employable as cyclic urea compounds (e) are bridged cyclic urea structures, wherein two cyclic urea structures are bridged via the radical R. The cyclic urea structures are preferably identical and the bridge is preferably a 1- to 3-membered hydrocarbon which may be substituted.

In one embodiment R is an isocyanate-reactive group, preferably a reactive group selected from a terminal —OH or NH₂ group. In a particularly preferred embodiment R is unsubstituted.

R is very particularly preferably a linear, unsubstituted hydrocarbon radical selected from methyl, ethyl, propyl, pentyl and hexyl, in particular R is a methyl radical.

Cyclic urea structures of formula 1 are known and have already been described numerous times, for example in US 2013281451. The synthesis may for example be carried out starting from N-haloalkyl-3-alkylurea, such as 1-(2-chloroethyl)-3-methylurea. These urea compounds are cyclized in the presence of sodium hydride. This synthesis is also described in US 2013281451. The synthesis may alternatively be carried out starting from urea and diamines, as described for example in EP 976796, or by reaction of dialkyl carbonates with diamines, as described for example in EP 2548869.

If a polyurethane foam is to be obtained as the process product according to the invention blowing agents (f) are employed. Employable blowing agents (f) include chemically acting blowing agents and/or physically acting compounds. Chemical blowing agents are to be understood as meaning compounds which form gaseous products, for example water or formic acid, by reaction with isocyanate. Physical blowing agents are to be understood as meaning compounds which are dissolved or emulsified in the starting materials for the production of polyurethane and vaporize under the conditions of polyurethane formation. These include for example hydrocarbons, halogenated hydrocarbons, for example halogenated saturated hydrocarbons, and other compounds, such as for example perfluorinated alkanes, such as perfluorohexane, chlorofluorocarbons, and ethers, esters, ketones and/or acetals, for example (cyclo)aliphatic hydrocarbons having 4 to 8 carbon atoms, or hydrofluorocarbons, such as Solkane® 365 mfc, or gases, such as carbon dioxide.

In a preferred embodiment of the present invention the blowing agent (f) employed is a mixture of these blowing agents comprising (f1) water, particularly preferably exclusively water. In particular, the blowing agent (f) employed is water, preferably exclusively water, when flexible polyurethane foams are to be obtained.

The blowing agent amount is preferably adjusted to obtain the desired density. To produce the flexible polyurethane foams the blowing agent quantity is preferably selected such that the density of the polyurethane foam according to the invention is in the range from 30 to 70 g/l, preferably 40 to 60 g/l and in particular 45 to 55 g/l. In particular, exclusively water is used in an amount of 1% to 6% by weight, preferably 2% to 5% by weight, more preferably 2.5% to 4.5% by weight and in particular 3.0% to 4.5% by weight, based on the total weight of components (b) to (f).

Examples of auxiliaries and/or additives (g) employed include surface-active substances, foam stabilizers, cell regulators, external and internal release agents, fillers, pigments, dyes, flame retardants, antistats, aromatic amine-reducing substances, for example lactams, hydrolysis stabilizers and fungistatic and bacteriostatic substances. Especially the use of lactams, such as ε-caprolactam, together with the inventive cyclic ureas of formula I results in a reduction in aromatic amines in the polyurethane.

Further details of the starting materials used can be found, for example, in the Kunststoffhandbuch [Plastics Handbook], volume 7, Polyurethane [Polyurethanes], edited by Günter Oertel, Carl-Hanser-Verlag, Munich, third edition 1993, chapter 5, Polyurethanweichschaumstoffe [Flexible polyurethane foams].

When producing the polyurethanes according to the invention, for example the particularly preferred flexible polyurethane foams, the polymeric compounds having isocyanate-reactive groups (b), the optionally employed chain extenders and/or crosslinking agents (c), the catalysts (d), the cyclic urea structure (e) and the optionally co-used blowing agents (f) and auxiliaries and/or additives (g) optionally are typically mixed to afford a so-called polyol component and in this form reacted with the polyisocyanates a).

The equivalent ratio of NCO groups of the polyisocyanates (a) to the sum of the reactive hydrogen atoms of components (b), (d), (e) and optionally (c) and (f) is generally 0.75 to 1.5:1, preferably 0.80 to 1.25:1. If the cellular plastics at least partially comprise isocyanurate groups, a ratio of NCO groups of the polyisocyanates (a) to the sum of the reactive hydrogen atoms of the components (b), (d), (e) and optionally (c) and (f) of 1.5 to 20:1, preferably 1.5 to 8:1, is typically used. A ratio of 1:1 here corresponds to an isocyanate index of 100. If flexible polyurethane foams are produced the mixing ratios are preferably chosen such that the equivalence ratio of NCO groups of the polyisocyanates (a) to the sum of the reactive hydrogen atoms of the components (b), (e) and (f) and, if present, (c) and (d) is preferably 0.5 to 0.95:1, particularly preferably 0.6 to 0.8:1 and in particular 0.65 to 0.75:1.

Production of the polyurethanes according to the invention is preferably carried out by the one-shot method, for example using high-pressure or low-pressure technology. The polyurethanes according to the invention are produced on a belt or preferably in a mold. The molded polyurethane foams can be produced in open or closed, for example metallic, molds.

It is particularly advantageous to proceed by what is called the two-component method, in which, as set out above, a polyol component is produced and foamed with polyisocyanate (a). The components are preferably mixed at a temperature in the range between 15 to 120° C., preferably 20 to 80° C., and introduced into the mold or onto the conveyor belt. The temperature in the mold is usually in the range between 15 and 120° C., preferably between 30 and 80° C.

The thus obtained polyurethane, for example the flexible polyurethane foam according to the invention, likewise forms part of the subject matter of the present invention. The flexible polyurethane foam according to the invention is preferably open-celled and can be used without being worked. It also has a preferably tack-free surface.

Polyurethanes according to the invention may be used for all customary polyurethane applications. The polyurethanes according to the invention are particularly preferably employed in the interior of buildings or means of transport on account of their advantageously low emissions characteristics. Polyurethane foams according to the invention are preferably used in vehicle construction, for example as carpet backing, for padded, seating or lounging furniture, for mattresses or cushions. A further field of use is in automotive safety components, resting surfaces, armrests and similar parts in the furniture sector and in automaking.

It has surprisingly been found that especially in the production of molded polyurethane foams the use of the component of formula 1 in combination with amine catalyst in an amount such that the content of tertiary nitrogen atoms is from 0.0001 to 0.003 mol/100 g of foam makes it possible to markedly reduce the content of aromatic amines and preferably lower it to below the limit of detection especially at the surface of molded foams even at an isocyanate index of markedly below 100 and a water content markedly above 1% by weight.

A further advantage is that in the case of a polyurethane, in particular a flexible polyurethane foam, according to the invention the content of aldehydes measured in the fully reacted polyurethane can be markedly reduced, often by more than 50%, relative to a conventionally catalyst polyurethane without addition of component (e).

Finally also improved are the mechanical properties of the polyurethane foam according to the invention, such as the compression set, in particular after hot and humid storage (wet compression set), and the air permeability and thus comfort.

The invention shall be elucidated hereinbelow with reference to examples:

Production of 1-methyltetrahydropyrimidin-2(1H)-one (cyclic urea structure 1 of formula 1, wherein n equals 3 and R is a methyl group):

To a stirred solution of N-methylpropane-1,3-diamine (800 g, 9.1 mol, 1.0 equiv.) and NaOMe (40.2 g, 744 mmol, 5% by weight) dimethyl carbonate (865 g, 9.6 mol, 1.5 equiv.) were added dropwise over 7 hours at 55° C. The mixture was stirred under reflux for a further 7 hours and then cooled and filtered. Volatile substances were removed and the crude product (1020 g, 8.9 mmol, 98%) having a purity>95% was further purified by fractional distillation in a Vigreux column at reduced pressure to afford the desired target substance in a purity greater than 99% (935 g, 8.2 mol, 90%; colorless oil which crystallizes to form a colorless solid at room temperature).

The product obtained had the following properties:
Boiling point: 108° C./16 mbar.
Melting point: 92° C.

Production of 1-aminopropyltetrahydropyrimidin-2(1H)-one (cyclic urea structure 2 according to formula 1, wherein n equals 3 and R is a 1-aminopropyl group):

Production was carried out analogously to the cyclic urea structure 1, wherein instead of 9.1 mol of N-methylpropane-1,3-diamine 9.1 mol (1194g) of 3,3′-diaminodipropylamine is employed.
Polyol 1: A glycerol-started polyoxypropylene-polyoxyethylene having a polyoxyethylene content of 13% by weight based on the content of alkylene oxide, a hydroxyl number of 28 mg KOH/g and predominantly primary hydroxyl groups.
Polyol 2: Polymer polyol based on styrene and acrylonitrile in a ratio of 2:1, solids content 44% by weight and a hydroxyl number of 20 mg KOH/g
Polyol 3: Glycerol-started polyoxypropylene-polyoxyethylene having a polyoxyethylene content, based on the content of alkylene oxide, of 74% by weight and a hydroxyl number of 42 mg KOH/g.
Polyol 4: Glycerol-started polyoxypropylene-polyoxyethylene having a polyoxyethylene content of 13% by weight, based on the content of alkylene oxide, a hydroxyl number of 35 mg KOH/g and about 85% primary hydroxyl groups.
Polyol 5: Polymer polyol/graft polyol with a copolymer of styrene/acrylonitrile in a ratio of 2:1 (m:m) having an OH number of 20 and a solids content of 45% by weight.
Polyol 6: Glycerol-started polyoxypropylene having a hydroxyl number of 42 mg KOH/g and exclusively secondary OH groups.
Catalyst 1: 33% by weight solution of triethylenediamine in dipropylene glycol.
Catalyst 2: N-[2-[2-(dimethylamino)ethoxyl]-N-methyl-1,3-propanediamine incorporable, tertiary amine catalyst from Evonik, obtainable under the trade name Dabco® NE 300
Catalyst 3: N,N-Dimethyl-N′,N′-di(2-hydroxypropyl)-1,3-propanediamine, obtainable from Huntsman under the trade name Jeffcat® DPA.
Catalyst 4: 3-(Dimethylamino)propylamine-started polyoxypropylene having a polyoxypropylene content of 77% by weight and a hydroxyl number of 250 mg KOH/g.
Catalyst 5: 10% by weight solution of dimethyltin dineodecanoate in polyol 1, obtainable under the trade name Fomrez® UL 28; PU catalyst from Momentive.
Catalyst 6: 3-Dimethylaminopropylamine (DMAPA)
Isocyanate 1: Mixture of MDI and higher polycyclic homologs of MDI having a viscosity at 25° C. of 210 mPas and an NCO content of 31.5% by weight.
Isocyanate 2: Mixture of 49 parts by weight of 4,4′-MDI, 48.6 parts by weight of 2,4′-MDI and 2.4 parts by weight of 2,2′-MDI; the NCO content is 33.5% by weight.
Isocyanate 3: Monomeric 4,4′-MDI having an NCO content of 33.5% by weight.
Stabilizer 1: Low-emission silicone stabilizer from Evonik, available under the trade name Tegostab B 8715 LF2.
Stabilizer 2: Low-emission silicone stabilizer from Evonik, available under the trade name Tegostab B 8716 LF2.

Proceeding from the starting materials reported in table 1, test panels having dimensions of 18.5×19.5×3.8 cm were produced in a closed mold at a mold temperature of 50° C. To this end a polyol component according to the compositions reported in the tables was produced, mixed with the specified isocyanate component at the specified isocyanate index in a high-pressure mixing head at 35° C. and the resulting mixture introduced into a mold heated to 60° C. The reported amounts of input materials refer to parts by weight. The MDA concentration is reported in ppm. The molding was removed from the mold after 5 minutes; the density was approx. 50 g/dm³.

TABLE 1

| | Comp. 1 | Example 1 | Example 2 | Example 3 |
|---|---|---|---|---|
| Polyol 1 | 76.65 | 76.65 | 77.85 | 76.65 |
| Polyol 2 | 15.00 | 15.00 | 15.00 | 15.00 |
| Polyol 3 | 2.00 | 2.00 | 2.00 | 2.00 |
| Catalyst 1 | 0.10 | 0.10 | | 0.10 |
| Catalyst 2 | 0.10 | 0.10 | | 0.10 |
| Catalyst 3 | 1.00 | | | — |
| Catalyst 4 | 1.00 | 1.00 | — | 1.00 |
| Catalyst 5 | | | | |
| ϵ-Caprolactam | | | | |
| 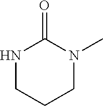 | — | 1.0 | 1.0 | — |
| (cyclic urea structure 1) | | | | |
| 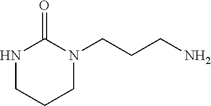 [SMILES: NCCCN1CCCNC1=O] | — | — | — | 1.0 |
| (cyclic urea structure 2) | | | | |
| Stabilizer 1 | 0.50 | 0.50 | 0.50 | 0.50 |
| Stabilizer 2 | 0.2 | 0.2 | 0.2 | 0.2 |
| Water | 3.45 | 3.45 | 3.45 | 3.45 |
| Isocyanate component | | | | |
| Isocyanate 1 | 37.5 | 37.5 | 37.5 | 37.5 |
| Isocyanate 2 | 42.1 | 42.1 | 42.1 | 42.1 |
| Isocyanate 3 | 20.4 | 20.4 | 20.4 | 20.4 |
| Index | 75.0 | 75.0 | 75.0 | 75.0 |
| Cream time [s] | 15 | 13 | 22 | 16 |
| Gel time [s] | 53 | 50 | 81 | 63 |
| Rise time [s] | 75 | 29 | 210 | 127 |
| 2,2′-MDA | 4 | 2 | <1 | <1 |
| 2,4′-MDA | 73 | 10 | <1 | 11 |
| 4,4′-MDA | 17 | <1 | <1 | 7 |
| Compression set (75%, 22 h, 70° C.) | 64.1% | 8.9% | | |
| Wet compression set (%) | 82.6% | 11.9% | | |
| Air permeability (dm³/s) | 0.286 | 0.450 | | |
| Formaldehyde [μg/m³] | 1037 | 571 | | |
| Acetaldehyde [μg/m³] | 327 | 206 | | |

| | Comp. 2 | Comp. 3 | Example 4 | Comp. 4 | Example 5 | Example 6 |
|---|---|---|---|---|---|---|
| Polyol 1 | 76.85 | 77.15 | 78.05 | 76.65 | 75.65 | 75.65 |
| Polyol 2 | 15.00 | 15.00 | 15.00 | 15.00 | 15.00 | 15.00 |
| Polyol 3 | 2.00 | 2.00 | 2.00 | 2.00 | 2.00 | 2.00 |
| Catalyst 1 | | | | 0.10 | 0.10 | 0.10 |
| Catalyst 2 | 0.20 | 0.20 | 0.20 | 0.10 | 0.10 | 0.10 |
| Catalyst 3 | | | | — | — | — |
| Catalyst 4 | | | | 1.00 | 1.00 | 1.00 |
| Catalyst 5 | 0.3 | | 0.3 | | | |
| ϵ-Caprolactam | 1.5 | 1.5 | | 1.0 | 1.0 | 1.0 |
| 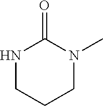 | | | 0.3 | | 1.0 | — |
| 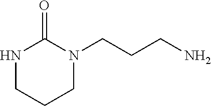 [SMILES: NCCCN1CCCNC1=O] | — | — | — | — | | 1.0 |
| Stabilizer 1 | 0.50 | 0.50 | 0.50 | 0.50 | 0.50 | 0.50 |
| Stabilizer 2 | 0.20 | 0.20 | 0.20 | 0.20 | 0.20 | 0.20 |
| Water | 3.45 | 3.45 | 3.45 | 3.45 | 3.45 | 3.45 |
| Isocyanate component | | | | | | |
| Isocyanate 1 | 37.5 | 37.5 | 37.5 | 37.5 | 37.5 | 37.5 |
| Isocyanate 2 | 42.1 | 42.1 | 42.1 | 42.1 | 42.1 | 42.1 |
| Isocyanate 3 | 20.4 | 20.4 | 20.4 | 20.4 | 20.4 | 20.4 |
| Index | 75.0 | 75.0 | 75.0 | 75.0 | 75.0 | 75.0 |
| Cream time [s] | 15 | 14 | 15 | 17 | 12 | 14 |
| Gel time [s] | 75 | 76 | 75 | 62 | 49 | 60 |
| Rise time [s] | 100 | 78 | 92 | 106 | 72 | 96 |
| 2,2′-MDA | — | — | — | 2 | <1 | <1 |
| 2,4′-MDA | 1 | — | — | 11 | 7 | 11 |
| 4,4′-MDA | <1 | — | — | <1 | <1 | 4 |
| Remarks | | Foam | | | | |
| | | collapsed | | | | |

Comparison 1 corresponds to a conventionally catalyzed foam. Fast reaction times are achieved but high levels of aromatic amines occur and aldehyde emissions are also high. Replacing an amine catalyst (cat 3) with cyclic urea structure 1 results in a similar reaction profile but the aldehyde emissions of the foam are markedly reduced (example 1). The content of aromatic amines is also markedly reduced. As the content of amine catalyst is further reduced the content of aromatic amine also falls further (example 2). Example 3 shows that this effect is also achieved with analogous cyclic ureas.

Comparative experiments 2 and 3 show that even when using large amounts of ε-caprolactam instead of the cyclic ureas a foam is obtained only with additional use of metal catalyst (Cat 5); otherwise the foam collapses. By contrast, the use of small amounts of cyclic urea 1 (0.3 parts instead of 1.5 parts) makes it possible to obtain a foam even without the use of metal catalyst (example 4). Finally, the additional use of inventive cyclic urea with ε-caprolactam (examples 5 and 6 compared to comparative example 4) results in markedly faster reaction times coupled with a reduced content of aromatic amine.

Aromatic Amines:

The determination of the concentration of aromatic amines in molded parts made of flexible polyurethane foam was based on the ISOPA I.I.I. test method: MDA detection method ISOPA I.I.I. ref. 11399, “Robust method for the determination of the diaminodiphenylmethane content of flexible polyurethane foams”. To this end, the specimens were sawn after production and immediately packed in aluminum foil and a plastic bag. The duration between demolding and packaging was 30 min.

The surface of the molded foam was cut off in the form of panels having a thickness of 0.5 cm. Specimens measuring 3 cm×3 cm each were cut out from these panels and stacked together to form a cube of 3×3×3 cm and measured. The flexible foam cube was placed in a beaker with 10 ml of 1% acetic acid (reported in % by mass). The cube was squeezed out twenty times using a ram (approx. 4 cm diameter) and the solution was transferred into a 50 ml flask. The compaction process was then repeated twice with 10 ml of 1% acetic acid each time, this acetic acid also being transferred into the flask after the compaction process. After combining the extracts obtained, the mixture was made up to 50 ml with 1% acetic acid. This solution was filtered through a 0.45 μm filter for preparation for the HPLC analysis. A double determination was carried out in all cases. The MDA contents are reported in ppm.

Emission Values:

The foam specimens from comparative example 8 and example 9 were analyzed using the chamber method followed by HPLC. Formaldehyde was determined by a procedure analogous to ASTM D-5116-06. The chamber size was 4.7 liters. The polyurethane specimens used were foams having a size of 110 mm×100 mm×25 mm from the core of the foam. The temperature in the measuring chamber during the measurement was 65° C., the relative humidity 50%. The air change rate was 3.0 litres per hour. The exhaust air stream comprising volatile aldehydes from the polyurethane was passed through a cartridge comprising silica coated with 2,4-dinitrophenylhydrazine over 120 minutes. The DNPH cartridge was then eluted with a mixture of acetonitrile and water. The concentration of formaldehyde in the eluate was determined by HPLC. In this setup the limit of detection for formaldehyde emissions is ≤11 μg/m³

Table 2 compares the use of the inventive cyclic urea structure 1 with an analogous, noninventive 5-membered cyclic urea structure (1-methyl-2-imidazolidone).

TABLE 2

| | Example 5 | Comparison 6 |
|---|---|---|
| Polyol 4 | 80.320 | 80.320 |
| Polyol 5 | 10.000 | 10.000 |
| Polyol 3 | 4.000 | 4.000 |
| Catalyst 4 | 0.875 | 0.875 |
| Catalyst 6 | 0.350 | 0.350 |
| Glycerol | 0.300 | 0.300 |
| Stabilizer 2 | 0.350 | 0.350 |
| Water | 3.450 | 3.450 |
| Cyclic urea structure 1 | 0.800 | |
| 1-Methyl-2-imidazolidone | | 1.200 |
| Isocyanate component | | |
| Isocyanate 1 | 40.00 | 40.00 |
| Isocyanate 2 | 23.00 | 23.00 |
| Isocyanate 3 | 22.00 | 22.00 |
| Polyol 3 | 5.00 | 5.00 |
| Polyol 6 | 10.00 | 10.00 |
| Index | 75 | 75 |
| Cream time [s] | 15 | 17 |
| Gel time [s] | 80 | 95 |
| Rise time [s] | 100 | 115 |
| 2,2′-MDA | 3 | 3 |
| 2,4′-MDA | 15 | 17 |
| 4,4′-MDA | <1 | 1 |
| Emissions | | |
| VOC (total emission/time | 1080 | 2124 |
| value (ppm)) | | |

The inventive 6-membered cyclic urea structure exhibits elevated catalytic activity compared to the analogous noninventive 5-membered urea structure, thus resulting in reduced starting, gel and rise times despite the smaller usage amount. The use of the inventive 6-membered cyclic urea structure according to the invention results in a reduction in the volatile organic compounds VOC according to VDA 277. The content of aromatic amines is also slightly reduced in the inventive example.

1. A process for producing polyurethanes comprising mixing
a) aromatic polyisocyanate with
b) polymeric compounds having isocyanate-reactive groups,
c) optionally chain extender and/or crosslinking agent,
d) catalyst,
e) 0.1% to 5% by weight, based on the total weight of components (a) to (f), of at least one cyclic urea structure of general formula 1 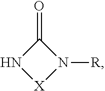
wherein —X— represents a substituted or unsubstituted, 3-membered radical and R represents a radical selected from the group consisting of a substituted or unsubstituted alkyl or heteroalkyl group, a substituted or unsubstituted aryl group and a substituted or unsubstituted alkyl-aryl or heteroalkyl-aryl group,
f) optionally blowing agent and
g) optionally additives,
to afford a reaction mixture and reacting the reaction mixture to afford the polyurethane.

2. The process according to claim 1, wherein the members of the radical X are selected from the group consisting of —NR¹—, —O—, —CR²R³—, —N═ and —CR⁴═, wherein the radicals R¹ to R⁴ each independently of one another represent hydrogen, an alkyl radical, or halogen.

3. The process according to claim 1, wherein X represents —(CH₂)₃—.

4. The process according to claim 1, wherein X represents —CH₂—C(CH₃)₂—CH₂—.

5. The process according to claim 1, wherein the content of water, based on the components (b) to (f), is 1% to 6% by weight.

6. The process according to claim 1, wherein the components (a) to (e) and, if present, (f) and (g) are reacted to afford the polyurethane at an isocyanate index of 50 to 95.

7. The process according to claim 1, wherein no further blowing agents are present in addition to water (f1).

8. The process according to claim 1, wherein in addition to the compound of formula 1 the catalyst comprises amine catalyst, wherein the amine catalyst has tertiary nitrogen atoms and is employed in an amount such that the content of tertiary nitrogen atoms in the amine catalyst, based on the weight of starting components (a) to (f), is from 0.0001 to 0.003 mol/100 g of foam.

9. The process according to claim 1, wherein the tertiary nitrogen atoms of the tertiary amino groups of the amine catalyst bear two radicals independently of one another selected from the group consisting of methyl (H₃C—)₂ ethyl radicals (H₃C—H₂C—) and a further organic radical.

10. The process according to claim 1, wherein the amine catalyst is selected from the group consisting of bisdimethylaminopropylurea, bis(N,N-dimethylaminoethoxyethyl)carbamate, dimethylaminopropylurea, N,N,N-trimethyl-N-hydroxyethylbis(aminopropyl ether), N,N,N-trimethyl-N-hydroxyethylbis(aminoethyl ether), diethylethanolamine, bis(N,N-dimethyl-3-aminopropyl)amine, dimethylaminopropylamine, 3-dimethylaminopropyl-N,N-dimethylpropane-1,3-diamine, dimethyl-2-(2-aminoethoxyethanol) and (1,3-bis(dimethylamino)propan-2-ol), N,N-bis(3-dimethylaminopropyl)-N-isopropanolamine, bis(dimethylaminopropyl)-2-hydroxyethylamine, N,N,N-trimethyl-N-(3 aminopropyl)bis(aminoethyl ether), 3-dimethylaminoisopropyldiisopropanolamine, N-[2-[2-(dimethylamino)ethoxy]ethyl]-N-methyl-1,3-propanediamine and mixtures thereof.

11. The process according to claim 7, wherein in addition to amine catalyst the catalyst comprises metal catalyst.

12. The process according to claim 1, wherein the aromatic polyisocyanate comprises isomers and homologs of diphenylmethane diisocyanate.

13. The process according to claim 1, wherein production of the reaction mixture comprises mixing an isocyanate component (A) comprising aromatic polyisocyanate (a) and a polyol component (B) comprising a mixture comprising polymeric compounds having isocyanate-reactive groups (b), catalyst (d) and blowing agent comprising water (e).

14. The process according to claim 1, wherein the reaction of the reaction mixture to afford the flexible polyurethane foam is carried out in a mold.

15. A polyurethane obtainable by a process according to claim 1.

16. A method of using the polyurethane foam according to claim 15, the method comprising using the polyurethane foam for producing cushions, seat pads and mattresses.

17. The process according to claim 1, wherein the members of the radical X are selected from the group consisting of —NR¹—, —O—, —CR²R³—, —N═ and —CR⁴═, wherein the radicals R¹ to R⁴ each independently of one another represent an ethyl or methyl, or halogen.

18. The process according to claim 1, wherein in addition to amine catalyst the catalyst comprises a tin (IV) catalyst.
